(19) United States
(12) Patent Application Publication
(10) Pub. No.: US 2008/0233245 A1
(43) Pub. Date: Sep. 25, 2008

(54) Liquid nutrient composition for improving performance

(76) Inventors: Lesley Joan White, Athens, GA (US); Holly Tasha Petty, Palm Bay, FL (US); Sean Conrad McCoy, Gainesville, FL (US); Hordur G. Kristinsson, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/077,620

(22) Filed: Mar. 19, 2008

Related U.S. Application Data
(60) Provisional application No. 60/918,951, filed on Mar. 19, 2007.

(51) Int. Cl. A23L 1/303; A23L 1/302

(52) U.S. Cl. 426/73; 426/72

(57) ABSTRACT

Novel, advantageous oral compositions formulated to affect any one or combination of the following: reduce physical and mental fatigue, enhance activity, improve recovery from activity, promote muscle performance, increase energy substrates, contribute to improved antioxidant defenses (i.e., reduce oxidative stress or lipid peroxidation, conserve anti-oxidants in the sera), enhance mood, assist in preventing primary and secondary diseases associated with fatigue and muscle atrophy associated with inactivity, improve nervous system (i.e., neuronal) and musculoskeletal (i.e., increase skeletal muscle protein synthesis, increase satellite cells) health, and contribute to improvements in overall health. The compositions of the subject invention are preferably used as a replacement for a snack or meal in cases of hunger or fatigue for individuals across the broad spectrum of human function from elite athletes to those individuals compromised by aging and certain disease states.

### CROSS REFERENCE TO RELATED APPLICATION

The present application claims the benefit of U.S. Provisional Application Ser. No. 60/918,951, filed Mar. 19, 2007, which is hereby incorporated by reference herein in its entirety, including any figures, tables, nucleic acid sequences, amino acid sequences, and drawings.

### BACKGROUND OF THE INVENTION

The benefits of physical activity and exercise extend far beyond weight management. Research shows that regular physical activity can help reduce the risk for several diseases and health conditions and improve overall quality of life. For example, physical activity is recognized for its role in preventing heart disease and stroke, reducing high blood pressure, controlling diabetes, improving flexibility and posture, and preventing bone loss. Further, physical activity has been associated with preserving cognitive function, enhancing memory (Radak, Z. et al., “The effects of training and detraining on memory, neurotrophins and oxidative stress markers in rat brain,” Neurochem Int., 49(4):387-92, (epub 2006, Mar 23)) and decreasing depressive symptoms (Midtgaard, J. et al., “The impact of a multidimensional exercise program on self-reported anxiety and depression in cancer patients undergoing chemotherapy: a phase II study,” Palliat Support Care, 3(3):197-208 (2005); Singh-Manoux, A. et al., “Effects of physical activity on cognitive functioning in middle age: evidence from the Whitehall II prospective cohort study,” Am Public Health, 95(12):2252-8 (2005); Fordyce, D. E. and J. M. Wehner, “Physical activity enhances spatial learning performance with an associated alteration in hippocampal protein kinase C activity in C57BL/6 and DBA/2 mice,” Brain Res, 619(1-2):111-9 (1993); and Kramer, A. F. et al., “Aging, fitness and neurocognitive function,” Nature, 400(6743):418-9 (1999)).

With exercise becoming increasingly accepted for its potential role in attenuating deterioration of neural function (Kempermann, G. et al., “Activity-dependent regulation of neuronal plasticity and self repair,” Prog Brain Res., 127:35-48 (2000)) and promoting restoration of CNS function following injury (Edgerton, V R et al., “Adaptations in skeletal muscle disuse or decreased-use atrophy,” Am J Phys Med Rehabil., 81(11Suppl):S127-47 (2002); and Edgerton V R et al., “Plasticity of the spinal neural circuitry after injury,” Ann Rev Neurosci., 27:145-67 (2004)), interventions to enhance daily activity can have important therapeutic outcomes.

Muscle activity is primarily based on a very fundamental biochemical mechanism, the breakdown of energy-rich phosphate bonds (ATP, adenosine triphosphate). ATP is the direct source of energy for muscle work and is in fact the only form of chemical energy, which can be converted by the muscle into mechanical work. During high physical activity of the body the ATP level in the muscles diminishes rapidly. Several substrates are available as sources for replenishing the ATP.

When there is low physical activity, fats are used for ATP production; at higher activity rates, glycogen in the muscle is the major energy supply. The energy from glycogen (carbohydrate) is released in exercising muscles up to three times as fast as the energy from fat. During the last half century it has been repeatedly demonstrated that exercise of a moderate intensity cannot be maintained when carbohydrate stores within the body are not sufficient or sufficiently available. Carbohydrates are the fuel from which body cells obtain energy for cellular activities and the major portion of carbohydrates utilised by the body are used for ATP production. The energy required for developing athletic activity, and indeed for all muscular work, comes primarily from the oxidation of glycogen stored in the muscles.

Muscle weakness and excessive physical and mental fatigue states contribute to reduced daily and leisure-time activities and consequently reduced physical fitness and worsening of fitness in a cycle. The cylindrical nature of reduced activity impacting overall health status and decreasing physical fitness in individuals under various aging and disease conditions (i.e., diabetes, cardiovascular disease, lupus, multiple sclerosis, rheumatoid arthritis, etc.) has been well documented. Inactivity and poor muscle strength are associated with various detrimental conditions, including functional limitations in activities of daily living, increased risk of falls and injury (Wolfson, C. and D. B. Wolfson, “Studies of the latency period in multiple sclerosis,” Acta Neurol Scan Suppl., 161:89-92 (1995)), premature osteoporosis, increased risk for development of hypokinetic diseases (such as heart disease, diabetes, and obesity), and reduced quality of life and independence. Therefore, effective strategies to minimize fatigue and muscle supplement are needed to attenuate premature disability, health complications, and increase quality of life.

One strategy for minimizing fatigue and muscle weakness is to enhance a diet with nutritional supplements that help meet/exceed additional nutritional demands that are dictated or necessitated by participation in exercise programs or deleterious physiological states associated with aging and various disease states. Many individuals and health care providers recommend the incorporation of additional nutritional foodstuffs as part of an adjunctive therapy in individuals susceptible to inadequate nutrition intake.

Amino acids are important in energy production during physical activity. Amino acids regulate how the body uses protein and plays a role in protein metabolism in muscles. They are oxidized in muscles and are sometimes the principal source of calories for muscle tissue. For example, the essential amino acid leucine has been shown to help spare muscle tissue, maintain nitrogen balance, and promote muscle growth and healing. Further, gamma-aminobutyric acid is an amino acid and neurotransmitter that is calming to the brain. This calming effect can be beneficial to athletes or patients who require concentration or steadiness. It may also provide assistance to those who are affected by stress. Creatine is another amino acid that serves to accelerate rapid energy transport in muscular cells.

Protein supplementation aids anabolic metabolism, as protein is a key nutritional component required for building muscles. Intensive recreational activities stimulate the need to rebuild and strengthen muscle fibers; hence protein supplementation is helpful to supply protein and amino acid needs following the recreational activities.

Vitamin supplementation aids energy metabolism, as vitamins are primary cofactors used in electron transfer steps in anabolic and catabolic metabolism. Vitamins such as vitamin C and vitamin E also function as antioxidants.

In outdoor recreational activities, ultraviolet light exposure can result in the production of free radicals in the body. Additionally, high aerobic respiration during these activities results in high oxygen levels and resultant free radical formation. Free radical formation leads to radical chain reactions and catabolism of protein and other tissues in the body, and it also contributes to physical exhaustion and potentially even carcinogenesis. Antioxidants serve to react with free radicals, terminating such deleterious radical chain reactions.

It is recommended that people consume 30% of total daily calories from fat, 55% from carbohydrates and 15% from protein. Fats perform many vital roles to aid in the body's functions. Triglycerides, the main form of fat in the body and in foods, constitute most of the stored energy in the body. Triglycerides yield over twice as much energy per gram as carbohydrates and protein (fats provide 9 calories per gram, while carbohydrates and protein provide 4 calories per gram). The free fatty acids, released from triglycerides are the major source for fuel for the body at rest and during light activity.

Triglycerides and other lipids (fat) in foods also carry fat-soluble vitamin A ,D, E and K to the small intestine. In doing so, lipids aid in absorption of these nutrients. Thus, without sufficient fat intake, an individual (particularly an active individual) runs the risk for developing deficiencies of these vitamins.

Taurine (also known as 2-aminoethanesulfonic acid) is an acidic chemical substance found in high abundance in the tissues of many animals. Taurine has also been implicated in a wide array of physiological phenomena including inhibitory neurotransmission, long-term potentiation in the striatum/hippocampus, membrane stabilization, feedback inhibition of neutrophil/macrophage respiratory bursts, adipose tissue regulation, and calcium homeostasis.

Many therapeutic applications of taurine have been investigated. Some conditions that taurine might be useful in treating include: cardiovascular diseases, hypercholesterolemia, epilepsy and other seizure disorders, macular degeneration, Alzheimer's disease, hepatic disorders, alcoholism, and cystic fibrosis. Recent studies show that taurine supplements taken by mice on a high-fat diet reduced their overall weight.

Acetyl-L-carnitine (also known as ALCAR) is an acetylated form of L-carnitine. ALCAR is absorbed by the gastrointestinal tract, enters cells, and crosses the blood-brain barrier more readily than unacetylated carnitine. It is claimed that ALCAR provides several benefits. For example, ALCAR has been implicated for use as a treatment for depression (250 mg per day for several weeks) and for clearing plaque/fatty deposits out of the veins and arteries.

Hitherto, alcoholic beverages have been limited in their ability to provide supplemental nutrients and/or addressing additional alimental needs necessitated by participation in recreational activities. Alcoholic beverages such as beer, wine, and mixed drinks are typically low in contents of protein, minerals, antioxidants and vitamins. For example, beer typically contains 13 g of carbohydrates, 1 g of protein, and no vitamins A or C per 12 fluid ounce serving; wine typically contains 2 g of carbohydrates, no protein, and no vitamins A or C per 12 fluid ounce serving; distilled alcoholic beverages such as vodka or martinis typically contain no carbohydrates, no protein, and no vitamins A or C per 12 fluid ounce serving.

The popularity of dietary supplements (i.e., foods, liquids, capsules, etc.) has grown rapidly in recent years. Dietary supplements are appealing as a quick means for attaining adequate nutrition, boosting the immune and metabolic systems, enhancing exercise and sport and work performance, and assisting with weight loss.

U.S. Pat. No. 5,851,578 issued to Soma Technologies describes a clear or translucent beverage that contains dietary fiber, vitamins and calcium intended for consumption by individuals with dietary deficiencies in these nutrients.

U.S. Pat. No. 4,992,282 issued to the Proctor & Gamble Company describes a vitamin and mineral fortified beverage that contains vitamin A, vitamin C, riboflavin, iron and calcium intended for consumption by individuals with dietary deficiencies in these nutrients.

U.S. patent application Ser. No. 09/199,433, now abandoned, describes a nutritionally active composition for bodybuilding. This invention describes the formulation of whey peptides, creatine monohydrate, potassium, phosphorous, and amino acids in a beverage vehicle to deliver nutrients to a recipient. The formulation described is alcohol free and is designed for bodybuilding applications.

U.S. Pat. No. 6,037,375 issued to Otsuka Pharmaceuticals describes a nonalcoholic beverage formulation that contains amino acids and carotenoid antioxidants. The invention is targeted to prevent fatigue during exercise.

None of the prior art describes a beverage, particularly an alcoholic beverage, with vitamin, antioxidant, minerals, amino acid, a fat source, a carbohydrate, taurine, and acetylcarnitine supplementation. The present invention satisfies the need for such a beverage that provides these needed nutrients for an improved dietary supplement for sustaining or enhancing energy levels during physical activity to promote physical performance and improve quality of life.

### BRIEF SUMMARY OF THE INVENTION

The subject invention provides novel, advantageous oral compositions formulated to affect any one or combination of the following: reduce physical and mental fatigue, enhance activity, improve recovery from activity, promote muscle performance, increase energy substrates, contribute to improved antioxidant defenses (i.e., reduce oxidative stress or lipid peroxidation, conserve anti-oxidants in the sera), enhance mood, assist in preventing primary and secondary diseases associated with fatigue and muscle atrophy associated with inactivity, improve nervous system (i.e., neuronal) and musculoskeletal (i.e., increase skeletal muscle protein synthesis, increase satellite cells) health, and contribute to improvements in overall health.

According to the subject invention, an oral consumption is provided, wherein the composition is prepared using a mixture of active components comprising: at least one B vitamin, vitamin C, vitamin E, creatine, leucine, taurine, a carbohydrate, GABA, ribose acetylcarnitine or carnitine, and a fat source. In one embodiment, the invention comprises an effective amount of at least one B-vitamin, Vitamin C, at least one fat soluble antioxidant, a short term energy substrate, leucine, a protein source, a fat source, at least one carbohydrate source, GABA, acetylcarnitine or carnitine, alpha lipoic acid, caffeine, taurine, Vitamin D, at least one essential fatty acid, choline, creatine, and coenzyme Q10. In certain embodiments, the carbohydrate source is an alcohol solution.

This unique combination of active components has fewer side effects that those observed with customary nutritional supplement compositions, particularly beverages. Moreover, the compositions of the invention are advantageous because of ease of usage; benefits associated with supplementing dietary protein, fiber, carbohydrate, vitamins, and antioxidant needs; great taste and pleasing texture; storage characteristics, and their versatility in application in various foodstuffs, in particular beverage products.

In a preferred embodiment, the invention provides a liquid composition comprising: (a) at least one B vitamin, (b) vitamin C, (c) vitamin E, (d) creatine, (e) leucine, (f) taurine, (g) a carbohydrate, (h) GABA, (i) acetylcarnitine, (j) a fat source, (k) ribose, and (l) water in a quantity at least sufficient to provide a solution wherein the components (a) through (k) are substantially dissolved for immediate consumption by drinking. The liquid composition can comprise highly concentrated amounts of components (a) through (k) in water for admixture with a beverage (such as alcoholic beverages, juices, sodas, liquid dairy products, and the like).

In another embodiment, the present invention provides a composition that is suitable for producing the above liquid composition (i.e., a concentrated liquid for reconstitution or a solid composition containing the components (a) through (k), where the concentrated liquid or solid composition can be obtained by homogeneously mixing liquid or solid components of (a) through (k), respectively). The concentrated liquid or solid composition can then be reconstituted into a beverage consumable by humans by mixing the concentrated liquid or solid composition to an orally ingestible liquid. For example, one method for reconstituting the concentrated liquid or solid composition into a consumable beverage includes the step of adding water (such as step l above) in a quantity at least sufficient to substantially dissolve all of the concentrated liquid or solid composition to form a drinkable solution (also referred to herein as a beverage). It is contemplated herein that the concentrated liquid or solid composition can be used for various applications in addition to liquid solutions such as medicines, nutraceuticals, foodstuffs, food additives, and feed additives.

Advantageously, the subject invention provides innovative compositions for aging individuals and those suffering from certain disease states or attempting to increase or maintain athletic performance. The subject compositions are particularly beneficial for health conscience and/or athletic consumers desiring a quick and easy protein-rich nutritional vehicle. In certain embodiments, the compositions of the subject invention are a healthy meal replacement/supplement or adjunctive therapy for the athlete to the non-athlete, including individuals suffering from disabling mental and physical maladies.

### BRIEF DESCRIPTION OF THE FIGURES

The file of this patent contains at least one drawing executed in color. Copies of this patent with color drawings(s) will be provided by the Patent and Trademark Office upon request and payment of the necessary fee.

FIG. 1 is an illustration of a beverage provided in accordance with the subject invention.

FIG. 2 is an illustration of a solid composition for admixture to a food product that is provided in accordance with the subject invention.

FIG. 3 is an illustration of tea bag product provided in accordance with the subject invention.

FIG. 4 is an illustration of dissolvable packet of product provided in accordance with the subject invention.

FIG. 5 is an illustration of pudding of product provided in accordance with the subject invention.

FIGS. 6A and 6B are illustrations of drug food products provided in accordance with the subject invention.

### DETAILED DISCLOSURE OF THE INVENTION

The subject invention provides compositions for oral consumption comprising a unique combination of alimental supplements, including methods for producing the composition and the use of the composition in beverages. The compositions of the invention are prepared by containing a mixture of active components comprising: at least one B vitamin, vitamin C, vitamin E, creatine, leucine, taurine, ribose, a carbohydrate, gamma amino butyric acid (GABA), acetylcarnitine or carnitine, and a fat source.

Specifically exemplified herein is a nutritional supplement in the form of a beverage product that comprises: at least one B-vitamin, vitamin C, at least one fat soluble antioxidant, GABA, acetylcarnitine or carnitine, ribose, creatine, choline, taurine, essential fatty acids, caffeine, coenzyme Q10, a short term energy substrate, leucine, a protein source, and at least one carbohydrate source.

It is contemplated herein that the subject nutritional supplements will improve the diet and health of individuals and animals who suffer from certain diseases or age-related disorders. Accordingly, one embodiment of the invention is directed to novel methods for improving the health of individuals diagnosed with autoimmune diseases, cardiovascular disease, metabolic syndromes or age-related disorders. In particular, a combination of an effective amount of at least one B-vitamin, Vitamin C, Vitamin E, creatine, GABA, acetylcarnitine, leucine, taurine, ribose, at least one fat in the form of a protein source, and at least one high-fiber carbohydrate is provided in various orally digestible forms (such as in a beverage, pudding mixture, nutritional bar, and the like).

Examples of autoimmune diseases, and age-related disorders of the invention include, but are not limited to, diabetes, celiac disease, multiple sclerosis, lupus, chronic fatigue syndrome, high cholesterol, diabetes, rheumatoid arthritis, cardiovascular disease, metabolic syndrome, sarcopenia and a diet lacking specific inclusion of nutraceuticals, nutrients, and conditionally essential nutrients and vitamins.

In certain embodiments, the compositions of the invention contain additional ingredients that aid in the digestive process to relieve constipation generally associated with some commonly prescribed medications as well as aid in energy metabolism, muscle metabolism and growth, fatigue reduction, and mood enhancement. One additional ingredient includes various high-fiber ingredients that can be added to oral compositions. In doing so, it is important to consider appropriate high-fiber candidates based on composition characteristics.

Where the composition (i.e., drink) is less viscous in nature, a high fiber constituent would be more appropriate. High fiber constituents for use in less viscous compositions include, but are not limited to, arabinogalactan, gum Arabic, partially hydrolyzed guar gum, inulin, and fructooligosaccharides. In higher viscosity applications, the following fibers can be used: guar gum, tragacanth gum, and konjac flour. Oat-B-glucan ingredients are specifically formulated for beverage applications as well as highly viscous applications (such as yogurt, pudding, ice cream, and frozen desserts).

To increase viscosity during processing the following classes of fibers are used: cereal based fibers; pectin; sugar beet fiber; cellulose; modified celluloses; inulin; psyllium pea fiber; apple fiber; prune, date, raisin, and fig fiber; polydextrose. Mixing the above ingredients in a slow, high shear fashion will produce the best results in the majority of cases. Preferably, these high fiber ingredients are coagglomerated with water soluble ingredients for better suspendability.

In a related embodiment, the nutritional supplement described herein are provided to athletic individuals diagnosed with who wish to improve overall energy levels and exercise performance.

In another related embodiment, the nutritional supplement composition described herein is provided to consumers in the form of an energy drink, who wish to improve mood, protein synthesis, metabolism, and improve and conserve cellular defenses through the incorporation of various antioxidants. In a related embodiment, the composition is combined with an alcoholic beverage to provide the consumer with a beverage that provides both performance and mood enhancing nutritional supplements.

According to the subject invention, the composition includes creatine. Exercise augments energy demands both within and external to muscle. Creatine may be derived through endogenous synthesis or through exogenous dietary creatine sources. Creatine phosphate is essential for short-term energy supply during anaerobic conditions and also for energy transfer from mitochondria to contractile muscle. Muscle cannot function efficiently or at a high level of power output if reserves of creatine are low or sub-optimal. Depletion of creatine in athletes causes poor performance and poor efficiency. The compositions of the invention, which provide creatine, are thus useful as a supplement for improving athletic performance. In a preferred embodiment, the nutritional supplement comprises creatine, such as creatine monohydrate or creatine phosphate.

Preferably, an orally digestible composition of the invention comprises about 0.01 to 10 grams of creatine monohydrate; about 750 mg of Vitamin E; about 0.01 to 30 mg of Vitamin C, about 0.01-20 g of leucine; about 0.01-10 g/day of GABA; 0.01-10 g/day of acetylcarnitine; 0.01-5 g of choline; 0.01-10 g of taurine; about 0.01-1200 mg/day of Vitamin D; about 0.01-1200 mg/day of Calcium, about 0.01-10 g of caffeine; about 0.10-50 grams of ribose, and at least one or any combination of more than one of the following B vitamins: B₁ (thiamine mononitrate) at about 1 to 20 mg; B₂ (riboflavin) at about 1 to 20 mg; B₃ (niacinamide) 0.01 mg to log); B₅ at about 1 to 50 mg; B₆ at about 1 to 10 mg; Biotin at about 1 to 300 micrograms; Folic acid at about 1 to 400 micrograms; B₁₂ at about 1 to 1000 micrograms, one or more of the essential fatty acids, a protein source, a carbohydrate source, per serving. The protein source is selected from any one or more of the following: whey protein 0.01 to 30 g, soy protein 0.01 to 30 g, casein protein 0.01 to 30 g, albumin 0.01 to 30 g including one or more of the following fat sources: sunflower oil 0.01 to 30 g, canola oil 0.01 to 30 g, safflower 0.01 to 30 g, or medium chain triglycerides. A carbohydrate source is selected from any one or more of the following: glucose 0.01 to 50 g, sucrose 0.01 to 50 g, lactose 0.01 to 50 g along with 0.01 to 10 g of fibers methylcelluloses (hydroxyproply-, carboxy), pectins, carageenan, acacia, tragacanth, guar, xanthan, arabinogalactan, inulin, konjac flour, and polydextrose. Even more preferably, a solid composition (such as a food bar) of the invention comprises about 0.01 to 5.00 grams of creatine monohydrate; about 500 to 15000 mg of GABA, 0.01-10 g/day acetylcarnitine; about 0.01-300 mg of R-alpha lipoic acid; about 35 grams of ribose; about 2 g of leucine; about 1 to 50 mg of choline; vitamin C (ascorbic acid) 20-120 mg and at least one or any combination of more than one of the following B vitamins: B₁ (thiamine mononitrate) at about 1 to 20 mg; B₂ (riboflavin) at about 1 to 20 mg; B₃ (niacinamide) at about 5 to 25 mg; B₅ at about 1 to 50 mg; B₆ at about 1 to 10 mg; Biotin at about 1 to 300 micrograms; Folic acid at about 1 to 400 micrograms; B₁₂ at about 1 to 1000 micrograms; Vitamin E at about 0.1-5 mg alpha-tocopherol; taurine at about 0.01-2 g, protein at about 0.1-40 g/serving, fat at about 0.01-10 g; and carbohydrate at about 6-9% (g/100 mL) and 0.1-25 g for less viscous sport drink applications). For more viscous, high protein applications, the amount of carbohydrates could range from 0.01 to 27 g/serving (drink supplement serving ranging from 8-15 oz.

Fat sources included in the compositions of the invention include, but are not limited to, food appropriate oils (either modified and/or in their natural state). Preferably, compositions of the invention include fat sources with higher percentages of diacylglycerols (DAGs) and medium-chain triglycerides (MCTS, such as those found in coconut and palm-kernel oils), which are metabolized differently than triacylglycerols commonly found in oils. More preferably, compositions of the invention will contain oils that are not hydrogenated and do not contain trans-fats. Examples of food appropriate oils added to the subject compositions include: Canola, sunflower, soy, and other plant derived oils. In addition, trace and or small (0.01-5 g) amounts of fats could come from proteins that are added to the beverage formulations. The present specification also describes a nutritional supplement with high protein content. Some of the healthy functions performed by protein include supplying energy and building and repairing muscle tissue. Accordingly, the nutritional supplements of the invention comprise at least one protein source. In certain embodiments, the nutritional supplements include of the invention include vegetable-based proteins and animal based proteins. Vegetable based proteins include any vegetable in which proteins may be collected, whether condensed, accumulated, or isolated. Examples of protein-providing vegetables include spelt, quinoa, amaranth, buckwheat, black rice, and the like. Additionally, leucine, creatine, arginine, and L-proprionyl carnitine have the ability to be produced by microbial methods or harvested from animal stock.

The nutritional supplement of the invention can act as an ideal carrier for vitamins and minerals and conditionally essential nutrients (CENs). Examples of vitamins that can be added to the compositions (including food bars) of the invention include, but are not limited to, vitamin A, vitamin K, para-aminobenzoic acid, niacin, inositol, and biotin. Examples of minerals that can be added include, but are not limited to, magnesium, iron, zinc, copper, manganese, sodium, potassium, calcium, selenium, chromium, molybdenum, chlorine, fluorine, phosphorus, sulfur, and iodine. Conditionally essential nutrients are organic compounds normally produced by the body; however, in disease states these compounds become “conditionally” essential. CENS have been efficacious in improving cardiovascular disease (CV) effects for the following supplementation amounts: L-arginine (6-21 g/day), proprionyl-L-carnitine (0.50-5 g/day), coenzyme Q10 (0.01-80 mg/day), and taurine (0.5-3 g/day), gamma amino butyric acid 0.01-10 g/day, acetylcarnitine (0.01-10 g/day). The nutritional supplement described herein can also contain botanicals or nutraceuticals including, but not limited to, bilberry, cascara, cat's claw, cayenne, cranberry, devil's claw, dong quai, echinacea, evening primrose oil, feverfew, garlic, ginger, ginkgo, Asian ginseng, Siberian ginseng, goldenseal, gotu kola, grape seed, green tea, hawthorn, kava, licorice, milk thistle, noni, saw palmetto, St. John's wort, valerian, melatonin, damiana, yerbe mate, guarana, red yeast rice, and the like.

The nutritional supplement in each or any of the product formulations of the invention may also comprise salts, seasonings, and flavorings (collectively “flavorings”) to make the food bar more desirable to the taste. The concentration of flavorings can be adjusted according to need and taste. Examples of flavorings include, but are not limited to, beef, lamb, chicken, turkey, fish, mint, peppermint, spearmint, cinnamon, nutmeg, cloves, ginger, wintergreen, vanilla, fruit, fruit extracts and essences, peppers, chili pepper, chocolate, caramel, sarsaparilla, sassafras, salt, wild cherry, ginger, nutmeg, honey questionable—due to presence of allergens contained therein, malt, grain flavors, paprika, garlic, and other flavorings well known to those of skill in the art.

The flavorings can be added in any proportion or combination to achieve the desired taste. For example, salt and vanilla can comprise any proportion of the total flavoring but generally each comprises less than about 2% of the nutritional supplement.

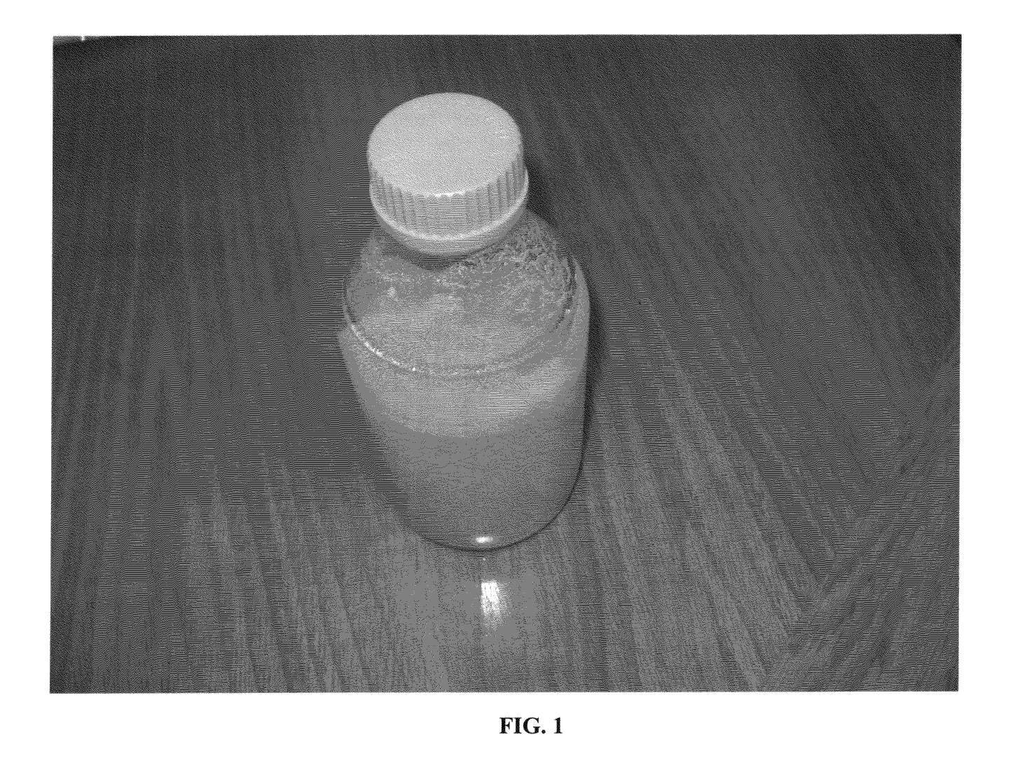

In one embodiment, the compositions of the invention are provided in the form of a beverage (see FIG. 1), which contains water and/or alcohol. Water performs the function of adding moisture to the mixture and helps the ingredients mix completely to form a homogeneous food product. The dry ingredients, particularly the proteins and carbohydrates, generally absorb water. Where the compositions of the invention are provided as an alcoholic beverage, the alcohol assists in the dissolving process for some of the conditionally essential nutrients, vitamins, minerals, proteins, and additional nutritional components.

In certain embodiments, compositions of the invention are provided in a container composed of water-permeable material that enables any potable liquid to easily flow therethrough (such as tea bags). Accordingly, compositions of the invention can be dissolved or steeped in liquid to provide a beverage.

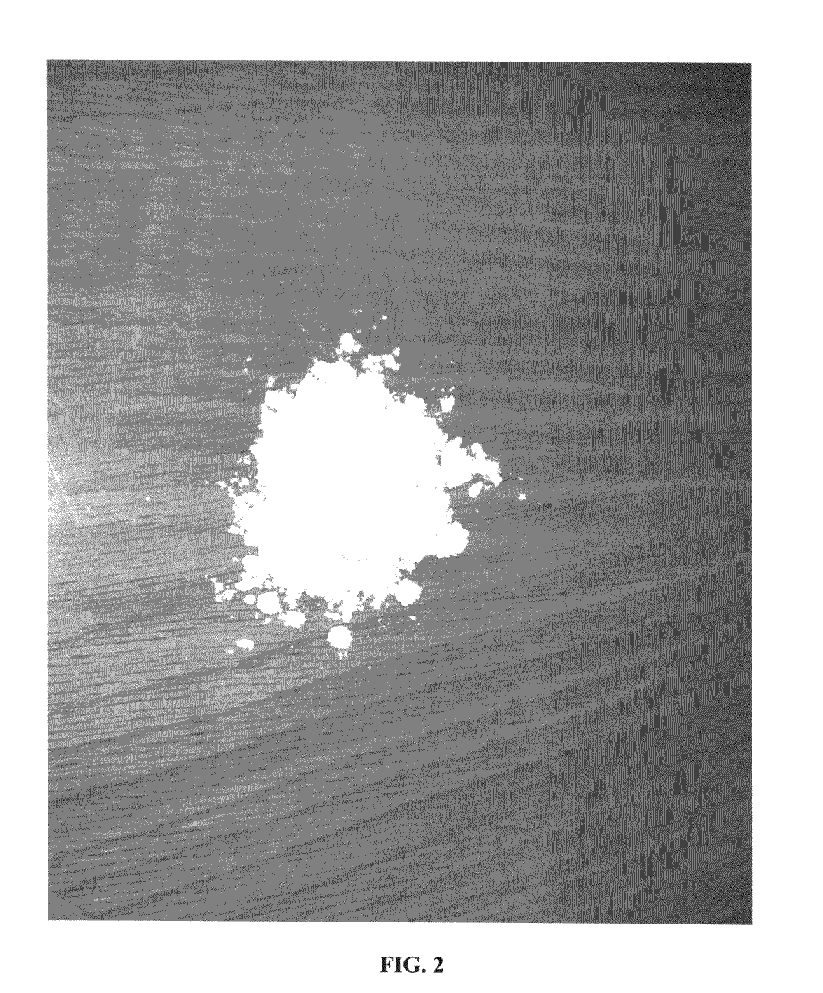

Alternatively, the compositions of the invention can be provided in solid form (see FIG. 2), which can be mixed with liquids such as water, to form a beverage or other orally digestible form (such as pudding). In certain embodiments, the compositions of the invention can be mixed with other solids and/or liquids that can be refrigerated, frozen, or cooked (such as baking in the oven, cooking over a stovetop, cooking in a microwave, and the like) to form orally digestible products. For example, the compositions of the invention can be mixed with cake or cookie batter, cake or cookie mixes, bread mixes, dough, ice cream ingredients, soups, and the like.

According to the subject invention, the compositions include the following active components:

(a) Acetylcarnitine: important aspects of acetylcarnitine supplementation that may promote health outcomes across a diverse population are as follows: acetylcarnitine is involved in mitochondrial metabolism (Hagen, T M Proc. Natl. Acad. Sci. USA 95 (1998); it has been reported as having anti-oxidant properties (Kaur, J. Neurosci. Lett. 301 (2001); it has been reported to act as an acetyl donor and thus assist in maintaining acetylcholine levels (Ratnakumari, L., J Pharmacol. Exp. Ther. 274 (1995); it has been reported to improve both spatial and temporal memory in aged rats (Liu, J. Proc. Natl. Acad. Sci. USA 99 (2002); it is a source of acetyl groups available for acetylcholine synthesis and is selectively taken up by the brain (Kuratsune, H. Biochem. Res. Commun. 231 (1997); it is associated with (when combined with lipoic acid) restoration of mitochondrial function, lowers oxidants and neuron RNA oxidation while it increases activity and cognition (Ames B N and Lui 2004 and Fracasso P et al. 2004) in old rats; it attenuates oxidative stress and cell death induced by Amyloid beta toxicity (such as from Alzheimer's disease); and it is a source of carnitine and carnitine is associated with the transport of long chain free fatty acids (FFA) across the mitochondrial membrane to aid in fat metabolism for both weight loss and fatigue reduction when energy demand is high. (b) Carnitine: important aspects of leucine supplementation that may promote health outcomes across a diverse population are as follows: there is evidence for a beneficial effect of L-carnitine supplementation in training, competition, and recovery from strenuous exercise and in regenerative athletics. (Karlic H, Lohninger A. Nutrition. 2004 Jul-Aug; 20(7-8):709-15.); after maximal exercise intensity, treatment with L-carnitine significantly increased both maximal oxygen uptake, and power output, moreover, at similar exercise intensities in the L-carnitine trial oxygen uptake, carbon dioxide production, pulmonary ventilation and plasma lactate were reduced (Vecchiet L, et al Eur J Appl Physiol Occup Physiol. 1990; 61(5-6):486-90); preliminary data have demonstrated beneficial effects of carnitine supplementation to improve muscle function and exercise capacity in patients with Peripheral arterial disease. (Brass E P, Hiatt W R. J Am Coll Nutr. 1998 Jun; 17(3):207-15.); L-carnitine supplementation in selected uremic patients may yield clinical benefits by ameliorating several conditions, such as erythropoietin-resistant anemia, decreased cardiac performance, intradialytic hypotension, muscle symptoms, as well as impaired exercise and functional capacities; L-carnitine may positively influence the nutritional status of hemodialysis patients by promoting a positive protein balance, and by reducing insulin resistance and chronic inflammation, possibly through an effect on leptin resistance. (Calvani M, et al. Ann N Y Acad Sci. 2004 Nov; 1033:52-66.); several experimental studies have shown that levocarnitine reduces myocardial injury after ischemia and reperfusion by counteracting the toxic effect of high levels of free fatty acids, which occur in ischemia, and by improving carbohydrate metabolism; in addition to increasing the rate of fatty acid transport into mitochondria, levocarnitine reduces the intramitochondrial ratio of acetyl-CoA to free CoA, thus stimulating the activity of pyruvate dehydrogenase and increasing the oxidation of pyruvate; supplementation of the myocardium with levocarnitine results in an increased tissue carnitine content, a prevention of the loss of high-energy phosphate stores, ischemic injury, and improved heart recovery on reperfusion; clinically, levocarnitine has been shown to have anti-ischemic properties; in small short-term studies, levocarnitine acts as an antianginal agent that reduces ST segment depression and left ventricular end-diastolic pressure (Ferrari R, Merli E, Cicchitelli G, Mele D, Fucili A, Ceconi C. Ann N Y Acad Sci. 2004 Nov; 1033:79-91.).

(c) Creatine. important aspects of creatine supplementation that may promote health outcomes across a diverse population are as follows: cardiac and skeletal muscle creatine levels are depressed in patients with congestive heart failure (Kuethe F 2006); in skeletal muscle, creatine has been shown to improve muscle power output in healthy humans (Kilduff L P et al 2002) and diseases states (Kuethe F 2006); creatine supplementation in combination with strength training amplifies the training-induced increase in satellite cell number and myonuclei concentration in human skeletal muscle fibres, thus allowing an enhanced muscle fibre growth in response to strength training (Olsen s et al 2006); oral creatine supplementation stimulates muscle hypertrophy during rehabilitative strength training, where this effect may be mediated by a creatine-induced change in MRF4 and myogenin expression. (Hespel P. et al 2001 J of Physiol.); creatine supplementation was recently found to enhance muscle functional capacity in patients with various forms of neuromuscular diseases or muscular dystrophies (Tarnopolsky & Martin, 1999; Walter et al. 2000) as well as in McArdle's disease (Vorgerd et al. 2000); combined creatine and protein supplementation in conjunction with resistance training promotes muscle GLUT-4 content and glucose tolerance in humans (Derave W et al 2003); in elderly women, short-term oral creatine supplementation increases the ability to perform lower-body functional living tasks involving rapid movements (Canete s et al 2006); creatine supplementation led to increases in fat-free mass, peripheral muscle strength and endurance, health status, but not exercise capacity; creatine may constitute a new ergogenic treatment in COPD (Fuld J P et al 2005); creatine increases the anaerobic power and work capacity of sedentary people of different ages during maximal pedalling tasks (Wiroth J B 2001).

(d) Taurine: important aspects of taurine supplementation that may promote health outcomes across a diverse population are as follows: taurine produces a beneficial effect on lipid metabolism and may have an important role in cardiovascular disease prevention in overweight or obese subjects. (Zhang M, Bi L F, Fang J H, Su X L, Da G L, Kuwamori T, Kagamimori S. Amino Acids 2004); after supplementation in men 18-20 yrs, the change in taurine concentration showed positive correlations with the changes in exercise time to exhaustion and maximal workload. The results suggest that taurine may attenuate exercise-induced DNA damage and enhance the capacity of exercise due to its cellular protective properties. (M. Zhang, I. Izumi and S. Kagamimori et al., Role of taurine supplementation to prevent exercise-induced oxidative stress in healthy young men, Amino Acids 26 (2004), pp. 203-207)

(e) Leucine: important aspects of leucine supplementation that may promote health outcomes across a diverse population are as follows: together, insulin and leucine allow skeletal muscle to coordinate protein synthesis with physiological state and dietary intake. (Norton L E, Layman D K, J Nutr. 2006 Feb; 136(2):533S-537S); BCAA (leucine, isoleucine and valine) supplementation prior to squat exercise decreased delayed onset muscle soreness (DOMS) and muscle fatigue occurring for a few days after exercise. These findings suggest that BCAAs may be useful for muscle recovery following exercise. (Shimomura Y, et al., J Nutr. 2006 Feb; 136(2):529S-532S); leucine is known to interact with the insulin signaling pathway to stimulate downstream signal control of protein synthesis, resulting in maintenance of muscle protein during periods of restricted energy intake; leucine also appears to modulate insulin signaling and glucose use by skeletal muscle; whereas total protein is important in providing substrates for gluconeogenesis, leucine appears to regulate oxidative use of glucose by skeletal muscle through stimulation of glucose recycling via the glucose-alanine cycle. (Layman D K, Walker D A. J Nutr. 2006 Jan; 136(1 Suppl):319S-23S).

(f) GABA: important aspects of GABA supplementation that may promote health outcomes across a diverse population are as follows: GABA supplementation has been demonstrated in improving cerebellar signs in cases of cortical cerebellar atrophy (CCA) as well as in controlling spasticity in persons with spinal cord injury (SCI). (Gazulla J et al., “Treatment of ataxia in cortical cerebellar atrophy with the GAB Aergic drug gabapentin. A preliminary study.” Eur Neurol, 52(1):7-11 (2004) and Priebe M M et al., “Effectiveness of gabapentin in controlling spasticity: a quantitative study,” Spinal Cord, 35(3):171-5 (1997)).

(g) Ribose: important aspects of ribose that may promote health outcomes are as follows: ribose has been shown to enhance the recovery of myocardial or skeletal muscle adenosine triphosphate (ATP) and total adenine nucleotide (TAN) levels as well as modulate the production of oxygen free radicals during and following ischemia or high-intensity exercise. See Dodd, SL et al., “The role of ribose in human skeletal muscle metabolism,” Med Hypotheses, 62(5):819-24 (2004). In addition, ribose has been linked with enhancing cardiac performance, including improving cardiac function in healthy as well as diseased hearts. See Pauly D F and Pepine C J, “D-Ribose as a supplement for cardiac energy metabolism,” J Cardiovasc Pharmacol Ther, 5(4):249-58 (2000); Zimmer H G and Ibel H, “Ribose accelerates the repletion of the ATP pool during recovery from reversible ischemia of the rat myocardium,” J Mol Cell Cardiol, 16(9):863-6 (1984); and Zimmer H G, “Normalization of depressed heart function in rats by ribose,” Science, 220(4592):81-2 (1983).

(h) Multivitamin Supplementation: important aspects of multivitamin supplementation that may promote health outcomes across a diverse population are as follows: Vitamins and minerals, such as iron, zinc, biotin or pantothenic acid, have been implicated in ensuring proper metabolic function, such as with mitochondrial metabolism. Deficiencies in vitamins and minerals have been linked with mitochondrial decay. It has been noted that mitochondrial decay can lead to DNA damage, neural decay and aging. These findings suggest that optimum intake of vitamins could enhance metabolism and could assist in slowing down aging and neural decay. (Ames, “Low micronutrient intake may accelerate the degenerative diseases of aging through allocation of scarce micronutrients by triage,” Proc Natl Acad Sci USA, 103(47):17589-94 (2006); and Ames et al., “Mineral and vitamin deficiencies can accelerate the mitochondrial decay of aging,” Mol Aspects Med, 26(4-5):363-78 (2005)).

(i) High Fiber: Depending upon the food matrix to be prepared in accordance with the subject invention, the following high fiber ingredients can be provided: cold-water soluble fiber products such as methylcelluloses (hydroxyproply-, carboxy), pectins, carageenan, acacia, tragacanth, guar, xanthan, arabinogalactan, inulin, konjac flour, and polydextrose; and/or hot-water soluble fiber products such as pectins, carboxymethylcellulose, carageenan, alginate, acacia, karaya, tragacanth, guar, locust bean gum, xanthan, gellan, arabinogalactan, inulin, konjac flour, and polydextrose. Depending on the desired characteristics of the final product, certain fiber contents are preferred over others. Preferably, for heat settings, gelled products, and/or other procedures employing heat treatment, hot water soluble fibers are applicable. In applications involving hot beverages or gelatins, a dry mix with incorporated hot soluble fibers would provide appropriate mouth-feel and/or a gelled matrix for consumption. In all other applications, whether it is a ready mix or ready-to-drink product, cold water soluble fibers are employed.

In one embodiment, the compositions of the invention comprise acetylcarnitine in combination with alpha lipoic acid. Important aspects of lipoic acid supplementation that may promote health outcomes across a diverse population are listed as follows: increases endogenous antioxidants; increases mitochondrial bioenergetics; enhances glucose uptake by increasing glucose transport at the cell surface (Bustamente J et al Free radical biology, 1998); increases ambulatory activity in rats (Hagen T M et al. 2002); reduces oxidative stress more effectively than either supplement alone (Hagen T M et al 2002); appears to maintain myocardial function. (Hagen T M et al 2002 Apr; 959:491-507); improves performance in old rats on memory tasks by lowering oxidative damage and improving mitochondrial function (Liu J et al 2002).

In another embodiment, the compositions of the invention further include caffeine. Important aspects of caffeine supplementation that may promote health outcomes across a diverse population are as follows: caffeine can result in a small, but statistically significant, recovery of isometric tension in fatigued canine hindlimb muscle in situ, although not nearly to the same degree as seen in isolated single muscle fibres. (Howlett R A, Kelley K M, Grassi B, Gladden L B, Hogan M C.); caffeine allows heart failure (HF) patients to exercise longer at peak effort. (Notarius C F, Morris B, Floras J S. 2006); caffeine ingestion has a large effect on reducing leg muscle pain during exercise among females, but this effect does not appear to be dose-dependent between 5 and 10 mg.kg body weight caffeine. (Motl R W, O'connor P J, Tubandt L, Puetz T, Ely M R, 2006); acute caffeine ingestion can significantly enhance performance of prolonged, intermittent-sprint ability in competitive, male, team-sport athletes. (Schneiker K T, Bishop D, Dawson B, Hackett L P, 2006); in untrained subjects, caffeine can improve endurance performance during prolonged exercise performed below AT and that the decrease of perceived exertion can be involved in this process. (Denadai B S, Denadai M L, 1998).

According to the subject invention, the compositions can further include Coenzyme Q10. Important aspects of Coenzyme Q10 supplementation that may promote health outcomes across a diverse population are as follows: oral CoQ10 improves functional capacity, endothelial function, and LV contractility in CHF without any side effects (Belardinelli R, et al. Eur Heart J. 2006 Aug 1; [Epub ahead of print]); being devoid of significant side effects CoQ10 may have a role as an adjunct or alternative to conventional agents in the treatment of hypertension. (Rosenfeldt F, Hilton D, Pepe S, Krum H. Biofactors. 2003; 18(1-4):91-100.); CoQ10 therapy demonstrated significant improvements in symptom class and a trend towards improvements in exercise time. (Rosenfeldt F, Hilton D, Pepe S, Krum H. Biofactors. 2003; 18(1-4):91-100.).

According to the subject invention, the compositions can further include choline. Important aspects of choline supplementation that may promote health outcomes across a diverse population are as follows: choline supplementation appears to lower homocysteine concentrations as well as lipid peroxidation. Lipid peroxidation is associated with oxidative stress and high homocysteine concentrations are associated with cardiovascular disease. Diets supplemented with choline may improve exercise performance (improved fatty acid oxidation) as well as lower the risk of cardiovascular disease. Sachan D S et al, “Decreasing oxidative stress with choline and carnitine in women,” J Am Coll Nutr, 24(3):172-6 (2005); Olthof M R et al., “Choline supplemented as phosphatidylcholin decreases fasting and postmethionine-loading plasma homocysteine concentrations in healthy men,” Am J Clin Nutr, 82(1):111-7 (2005); Sachan D S et al., “Increases in VO2max and metabolic markers of fat oxidation by caffeine, carnitine, and choline supplementation in rats,” J Nutr Biochem, 11(10):521-6 (2000)).

According to the subject invention, the compositions can further include complete or incomplete proteins. A large source of protein is milk, from which whey and casein are derived. Various forms of whey protein exist (i.e., whey protein concentrate (WPC) and/or whey protein isolate (WPI)) and can be included in the compositions of the invention, including hydrolyzed WPC/WPI, lactoferrin, and glycomacropeptide (GMP). GMPs have been shown to enhance cholestokinen production and interleukin release, aiding in the suppression of appetite and inflammatory response (Bastian, E., Ph.D., Director of Research and Development, Glanbia Ingredients, Richfield, Id.). Incomplete protein sources derived from and/or found in whey protein include branched chain Amino Acids (BCAAs), isoleucine, leucine, and valine. Casein can be used in sodium and or calcium form. Liquid egg whites can also be incorporated into the formulation and serve as a good source of the amino acids (AA) tyrosine, leucine, lysine, and valine. Soy protein can be used in various forms: agglomerated, hydrolyzed, as isolated soybean germ (ca. 40% protein, 16% fatty acids, and 34% carbohydrates).

According to the subject invention, the compositions can further include essential fatty acids. Important aspects of essential fatty acid supplementation that may promote health outcomes across a diverse population are as follows: Omega-3 and omega-6 supplementation play a very important role in the coagulation and in the inflammatory reaction and may be useful in treating inflammation and autoimmune disorders (sucha as rheumatoid arthritis, psoriasis, asthma, inflammatory bowel disorders) as well as decreasing the likelihood of death associated with myocardial infarction (Herbaut, C., Rev Med Brux, 27(4):S355-60 (2006); Mori, T A et al., “Omega-3 fatty acids and inflammation,” Curr Atheroscler Rep, 6(6):461-7 (2004); and Simopoulos Ap, “Omega-3 fatty acids in inflammation and autoimmune diseases,” J Am Coll Nutr, 21(6):495-505 (2002)).

Following are examples which illustrate procedures for practicing the invention. These examples should not be construed as limiting. All percentages are by weight and all solvent mixture proportions are by volume unless otherwise noted.

It should be understood that the examples and embodiments described herein are for illustrative purposes only and that various modifications or changes in light thereof will be suggested to persons skilled in the art and are to be included within the spirit and purview of this application.

### EXAMPLE 1

### Formulations

a) A dry food product mix (see FIG. 2): various contents are provided in sufficient quantity in an enclosed sealed container, that the end consumer may mix the product with various liquids (i.e., water, fruit juice, milk, aloe vera juice) to form the end product. The preferred embodiment will include a complex carbohydrate source of approximately 20 g; a protein source of approximately 15 g; 3 g of fat (medium chain triglycerides); 5 g of creatine phosphate; 5 g of leucine; 5 g of GABA; 5 g of acetylcarnitine; 500 mg of choline 5 g of taurine; 500 mg Vitamin D and Calcium; and 10 g of ribose. The remaining items will consist of the B-vitamin complex at 50% of the RDA for adults.

b) A carbonated liquid food product: dry mix ingredients 10 g of carbohydrate; 500 mg of acetylcarnitine; 1000 mg of taurine, 1 g of creatine; 1 g of leucine and 2.5 g of GABA are added into a large sealed mixing vat containing a solution comprised of water, flavorings, sugars, fats and vitamins. Solution will then undergo a carbonization process and the final end product container will be sealed.

c) A liquid food product mix (see FIG. 1): dry mix ingredients 20 g of carbohydrate; 20 g of protein; 5 g of fat (medium chain triglycerides); 5 g of leucine; 7.5 g of creatine; 5 g of GABA; 5 g of taurine; 1000 mg of choline; 3 g of acetylcarnitine; 500 mg of Vitamin D and Calcium. The remaining ingredients will consist of Vitamin C and B-complex Vitamins in a range of 10-75% of the RDA as necessary for palatability and vitality are added into a large sealed mixing vat containing a solution comprised of water, flavorings, alcohol sugars, fats and vitamins.

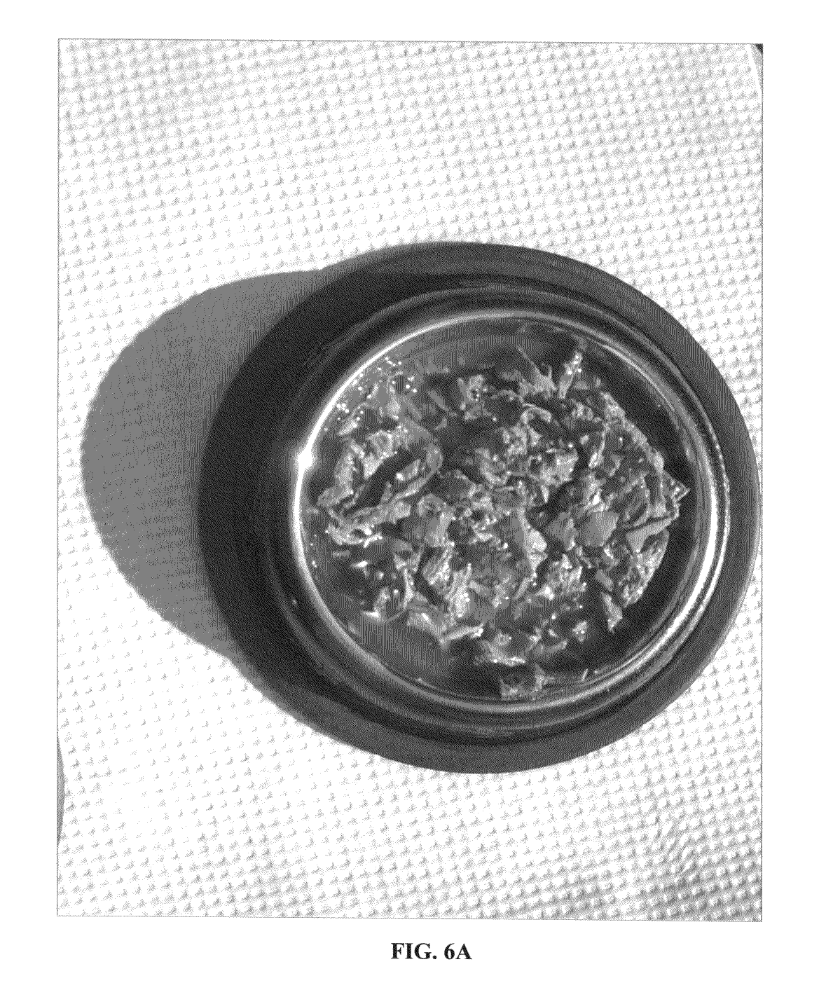

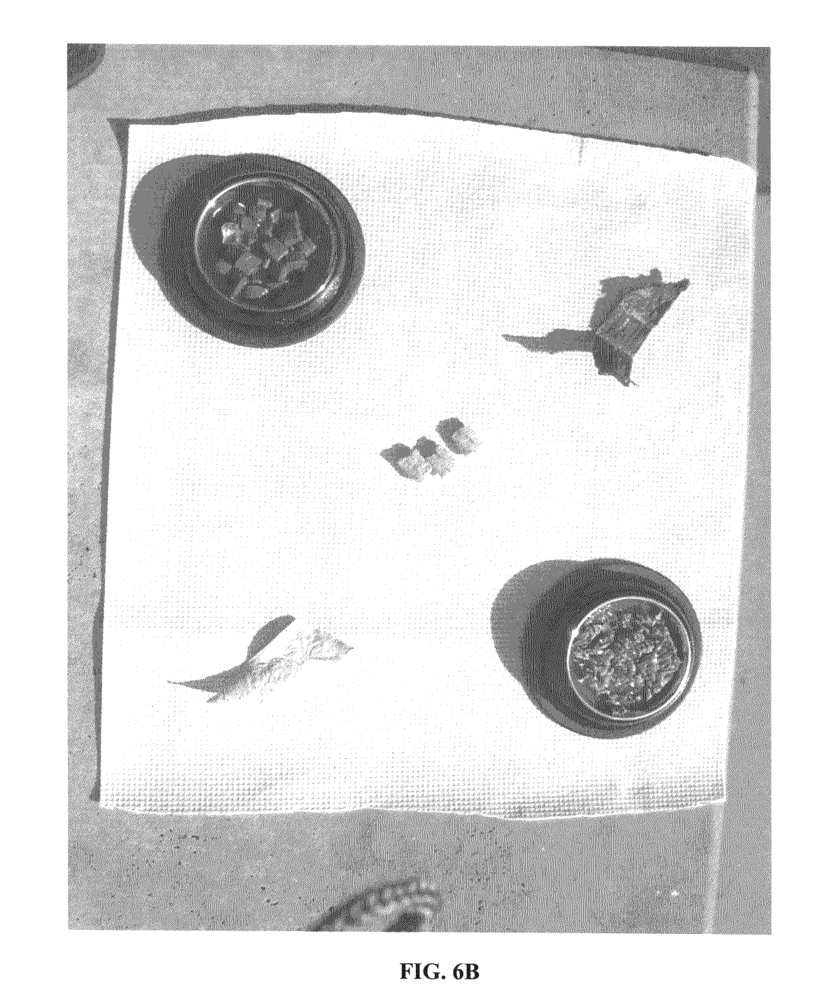

d) A solid food product: In one embodiment, the food product is mixed with a base of corn, soy or whey meal with adequate amounts of water, and flavorings to form a 5 mixture in a large vat. The product is then formed/molded into bite size morsels of various shapes ranging from ¼″ to 1″, the product is then dried and packaged in a container either plastic, cardboard, paper, or aluminum that maintains the proper water activity. Examples of solid food products are illustrated in FIGS. 6A and 6B.

In another embodiment, the food product is mixed with a base of corn, soy or 10 whey meal along with ground or chunk chicken, pig, cow, turkey by-products. These products will then be mixed with adequate water to form a gel solid. The final product will be packaged in a paper, plastic, aluminum or combination of one or more of these materials.

Any of the above food products can be provided to the user in the following 1 5 forms:

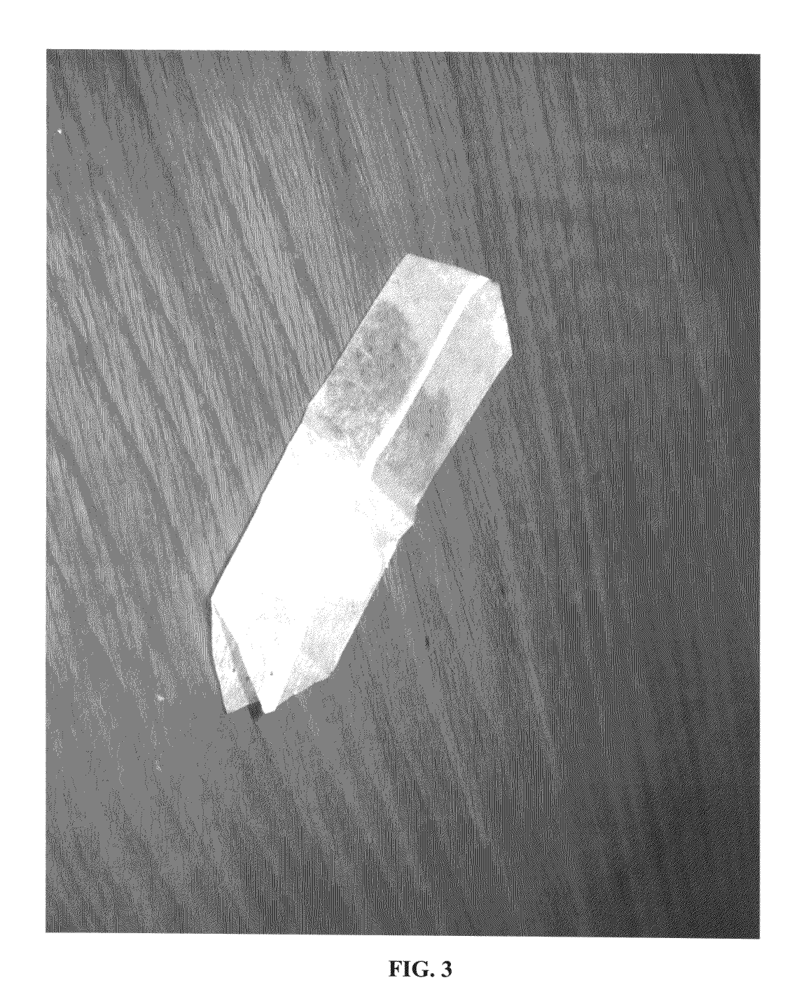

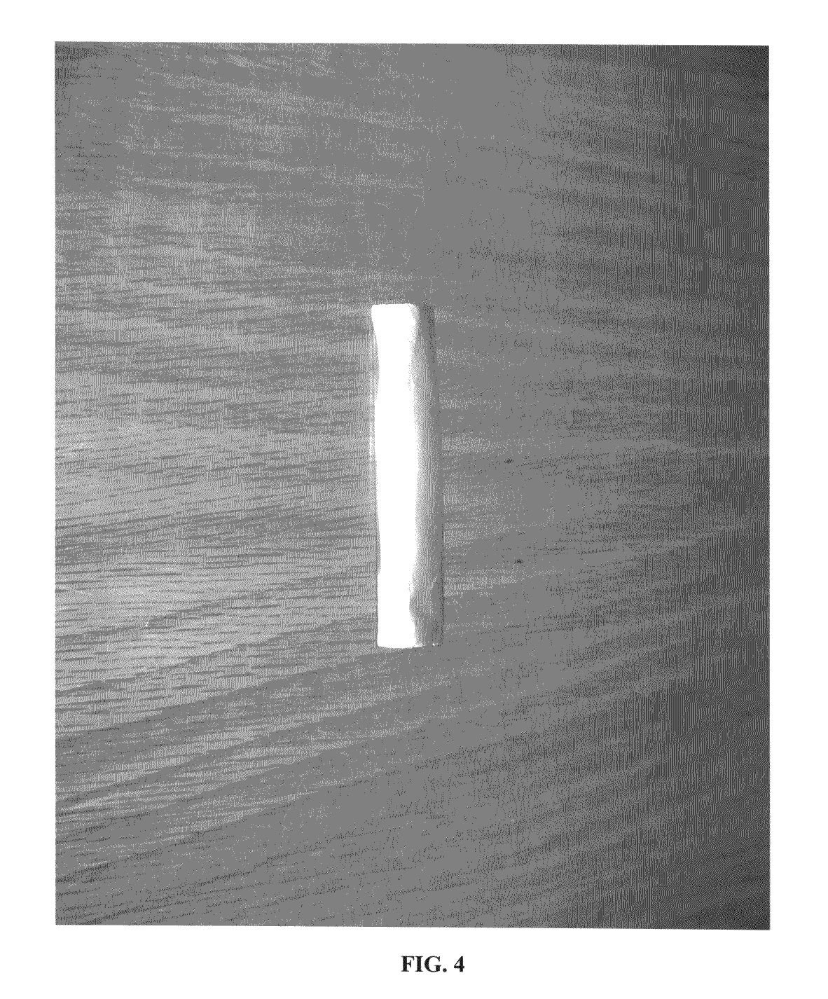

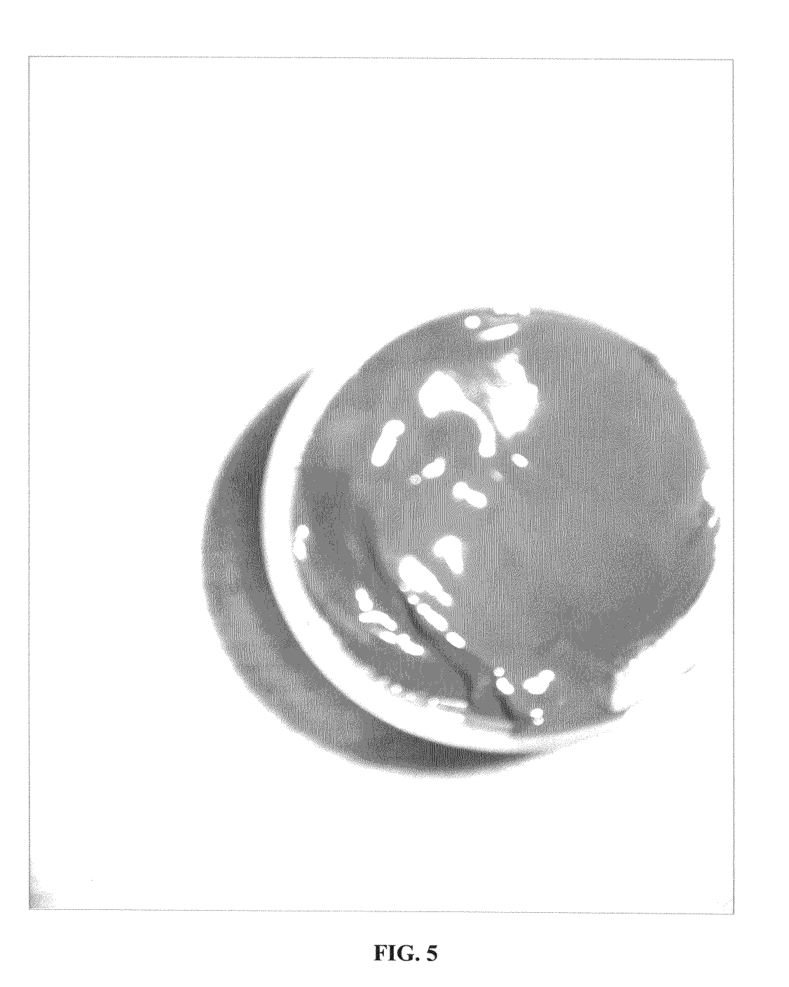

(i) Water permeable cellulose containers (see FIG. 3). Such containers enable the user to steep the food product (such as the dry mix product) in any warm or cold liquid. This process would provide users with the opportunity to form the nutritional supplement at their own leisure.

(ii) Plastic or dissolvable pouches. In one embodiment, the user dissolves either the contents of the plastic pouch or dissolves the entire pouch (where the pouch is dissolvable) in any liquid beverage.

(iii) Plastic containers. In one embodiment, the user will dispense desired portions from the plastic container for personal usage.

All patents, patent applications, provisional applications, and publications referred to or cited herein are incorporated by reference in their entirety, including all figures and tables, to the extent they are not inconsistent with the explicit teachings of the specification.

We claim:

1. A composition comprising: at least one B vitamin; vitamin C; vitamin E; a creatine compound; leucine; taurine; a carbohydrate; Gamma-Immunobutyric Acid (GABA); acetylcarnitine or carnitine; and a fat and/or protein source.

2. The composition of claim 1, wherein the composition is a liquid composition, wherein the liquid composition further comprises water and/or alcohol in a quantity sufficient to provide a beverage for consumption by humans.

3. The composition of claim 2, wherein the liquid composition contains: 10 g of carbohydrate; 500 mg of acetylcarnitine; 1000 mg of taurine, 1 g of creatine; 1 g of leucine and 2.5 g of GABA.

4. The composition of claim 2, wherein the liquid composition contains: 20 g of carbohydrate; 20 g of protein; 5 g of fat (medium chain triglycerides); 5 g of leucine; 7.5 g of creatine; 5 g of GABA; 5 g of taurine; 1000 mg of choline; 3 g of acetylcarnitine; 500 mg of vitamin D and calcium.

5. The composition of claim 2, wherein the liquid composition further comprises one or more essential fatty acids, caffeine, choline, vitamin D, calcium, coenzyme Q10, a ribose, and a short term energy substrate.

6. The composition of claim 5, wherein the liquid composition contains: about 0.01 to 10 g of creatine monohydrate; about 750 mg of vitamin E; about 0.01 to 30 mg of vitamin C, about 0.01-20 g of leucine; about 0.01-10 g of GABA; 0.01-10 g of acetylcarnitine; 0.01-5 g of choline; 0.01-10 g of taurine; about 0.01-1200 mg of vitamin D; about 0.01-1200 mg/day of calcium, about 0.01-10 g of caffeine; about 0.10-50 g of ribose; at least one or any combination of more than one of the following B vitamins: B₁ (thiamine mononitrate) at about 1 to 20 mg; B₂ (riboflavin) at about 1 to 20 mg; B₃ (niacinamide) 0.01 mg to 10 g); B₅ at about 1 to 50 mg; B₆ at about 1 to 10 mg; Biotin at about 1 to 300 micrograms; Folic acid at about 1 to 400 micrograms; B₁₂ at about 1 to 1000 micrograms; one or more essential fatty acids; a carbohydrate; and a protein source.

7. The composition of claim 6, wherein the protein source is selected from the group consisting of: whey protein 0.01 to 30 g, soy protein 0.01 to 30 g, casein protein 0.01 to 30 g, albumin 0.01 to 30 g including one or more of the following fat sources: sunflower oil 0.01 to 30 g, canola oil 0.01 to 30 g, safflower 0.01 to 30 g, or medium chain triglycerides.

8. The composition of claim 6, wherein the carbohydrate is selected from the group consisting of: glucose 0.01 to 50 g, sucrose 0.01 to 50 g, lactose 0.01 to 50 g along with 0.01 to 10 g of fibers methylcelluloses (hydroxyproply-, carboxy), pectins, carageenan, acacia, tragacanth, guar, xanthan, arabinogalactan, inulin, konjac flour, and polydextrose.

9. The composition of claim 1, wherein the composition is a concentrated liquid composition for reconstitution with any orally ingestible liquid.

10. The composition of claim 9, wherein the composition contains: 0.01 to 5.00 g of creatine monohydrate; about 500 to 15000 mg of GABA, 0.01-10 g acetylcarnitine; about 0.01-300 mg of R-alpha lipoic acid; about 35 grams of ribose; about 2 g of leucine; about 1 to 50 mg of choline; 20-120 mg of vitamin C (ascorbic acid); at least one or any combination of more than one of the following B vitamins: B₁ (thiamine mononitrate) at about 1 to 20 mg; B₂ (riboflavin) at about 1 to 20 mg; B₃ (niacinamide) at about 5 to 25 mg; B₅ at about 1 to 50 mg; B₆ at about 1 to 10 mg; Biotin at about 1 to 300 micrograms; Folic acid at about 1 to 400 micrograms; B₁₂ at about 1 to 1000 micrograms; vitamin E at about 0.1-5 mg alpha-tocopherol; taurine at about 0.01-2 g, protein at about 0.1-40 g/serving, fat at about 0.01-10 g; and carbohydrate at 0.01 to 27 g.

11. The composition of claim 1, wherein the composition is a solid composition for reconstitution with any orally ingestible liquid or solid.

12. The composition of claim 11, wherein the composition contains: 0.01 to 5.00 g of creatine monohydrate; about 500 to 15000 mg of GABA, 0.01-10 g acetylcarnitine; about 0.01-300 mg of R-alpha lipoic acid; about 35 grams of ribose; about 2 g of leucine; about 1 to 50 mg of choline; 20-120 mg of vitamin C (ascorbic acid); at least one or any combination of more than one of the following B vitamins: B₁ (thiamine mononitrate) at about 1 to 20 mg; B₂ (riboflavin) at about 1 to 20 mg; B₃ (niacinamide) at about 5 to 25 mg; B₅ at about 1 to 50 mg; B₆ at about 1 to 10 mg; Biotin at about 1 to 300 micrograms; Folic acid at about 1 to 400 micrograms; B₁₂ at about 1 to 1000 micrograms; vitamin E at about 0.1-5 mg alpha-tocopherol; taurine at about 0.01-2 g, protein at about 0.1-40 g/serving, fat at about 0.01-10 g; and carbohydrate at about 6-9% (g/100 mL).

13. The composition of claim 11, wherein the composition contains: a complex carbohydrate source of approximately 20 g; a protein source of approximately 15 g; 3 g of fat (medium chain triglycerides); 5 g of creatine phosphate; 5 g of leucine; 5 g of GABA; 5 g of acetylcarnitine; 500 mg of choline 5 g of taurine; 500 mg vitamin D and Calcium; and 10 g of ribose.

14. The composition of claim 11, wherein the solid composition is in the form of a powder/granular mix

15. The composition of claim 11, wherein the solid composition is retained within a container selected from the group consisting of: water permeable cellulose containers; plastic or dissolvable pouches; and plastic containers.

16 The composition of claim 1, wherein the fat source is one that demonstrates and one or more of the following characteristics: high percentage of diacylglycerols (DAGs), high percentage of medium-chain triglycerides (MCTS), non-hydrogenated, and lacks trans-fats.

17. The composition of claim 16, wherein the fat source is selected from the group consisting of: canola, sunflower, soy, and other plant derived oils.

18. The composition of claim 1, wherein the protein source is a vegetable-based protein or an animal based protein, or a combination of the two.

19. The composition of claim 18, wherein the vegetable based protein is provided from any one or more of the following: spelt, quinoa, amaranth, buckwheat, and black rice.

20. The composition of claim 1, further comprising any or more of the following ingredients: vitamin A, vitamin K, para-aminobenzoic acid, niacin, inositol, biotin, magnesium, iron, zinc, copper, manganese, sodium, potassium, calcium, selenium, chromium, molybdenum, chlorine, fluorine, phosphorus, sulfur, iodine, L-arginine (6-21 g/day), proprionyl-L-carnitine (0.50-5 g/day), coenzyme Q10 (0.01-80 mg/day), and taurine (0.5-3 g/day), gamma amino butyric acid 0.01-10 g/day, acetylcarnitine (0.01-10 g/day), bilberry, cascara, cat's claw, cayenne, cranberry, devil's claw, dong quai, echinacea, evening primrose oil, feverfew, garlic, ginger, ginkgo, Asian ginseng, Siberian ginseng, goldenseal, gotu kola, grape seed, green tea, hawthorn, kava, licorice, milk thistle, noni, saw palmetto, St. John's wort, valerian, melatonin, damiana, yerbe mate, guarana, and red yeast rice.

21. The composition of claim 1, further comprising any one or more flavoring compounds selected from the group consisting of: beef, lamb, chicken, turkey, fish, mint, peppermint, spearmint, cinnamon, nutmeg, cloves, ginger, wintergreen, vanilla, fruit, fruit extracts and essences, peppers, chili pepper, chocolate, caramel, sarsaparilla, sassafras, salt, wild cherry, ginger, nutmeg, honey, malt, grain flavors, paprika, and garlic.
